(19) United States
(12) Patent Application Publication
(10) Pub. No.: US 2013/0039250 A1
(43) Pub. Date: Feb. 14, 2013

(54) Method to Indicate MBMS Reception Status to Enable Service Continuity

(71) Applicant: Chia-Chun Hsu, Taipei City (TW)

(72) Inventor: Chia-Chun Hsu, Taipei City (TW)

(73) Assignee: MEDIATEK, INC., Hsin-Chu (TW)

(21) Appl. No.: 13/571,336

(22) Filed: Aug. 9, 2012

Related U.S. Application Data
(60) Provisional application No. 61/523,171, filed on Aug. 12, 2011.

(51) Int. Cl. H04H 20/71

(52) U.S. Cl. 370/312

(57) ABSTRACT

Network-assisted solutions are provided to maintain MBMS service continuity. In one novel aspect, a base station broadcasts MBMS service continuity (SC) indication to a plurality of user equipments (UEs) via a system information block (SIB). The MBMS SC indication comprises MBMS service area IDs (SAIs) supported by the current cell as well as neighbor frequencies. If a UE is in RRC_IDLE state, then the UE makes cell reselection decision based on the MBMS SC indication to maintain MBMS service continuity. If the UE is in RRC_CONNECTED state, then the UE reports MBMS reception status to the base station based on the MBMS SC indication via a dedicated RRC message. As a result, the base station can makes certain decisions including handover for the UE to maintain MBMS service continuity.

### CROSS REFERENCE TO RELATED APPLICATIONS

This application claims priority under 35 U.S.C. §119 from U.S. Provisional Application No. 61/523,171, entitled “Method to Indicate MBMS Reception Status to Enable Service Continuity”, filed on Aug. 12, 2011, the subject matter of which is incorporated herein by reference.

### TECHNICAL FIELD

The disclosed embodiments relate generally to Multimedia Broadcast and Multicast Service (MBMS), and, more particularly, to support MBMS service continuity for user equipments (UE) in wireless communication networks.

### BACKGROUND

A Long-Term Evolution (LTE) system offers high peak data rates, low latency, improved system capacity, and low operating cost resulting from simple network architecture. An LTE system also provides seamless integration to older wireless networks, such as Global System for Mobile Communications (GSM), Code Division Multiple Access (CDMA), and Universal Mobile Telecommunication System (UMTS). In LTE systems, an evolved universal terrestrial radio access network (E-UTRAN) includes a plurality of evolved Node-Bs (eNBs) communicating with a plurality of mobile stations, referred as user equipments (UEs).

Enhancements to LTE systems are considered by the third Generation Partnership Project (3GPP) so that they can meet or exceed International Mobile Telecommunications Advanced (IMT-Advanced) fourth generation (4G) standard. One of the key enhancements is to support bandwidth up to 100 MHz and be backwards compatible with the existing wireless network system. Carrier aggregation (CA), where two or more component carriers (CCs) are aggregated, is introduced into LTE-Advanced systems to improve overall system throughput.

Multimedia Broadcast and Multicast Service (MBMS) is a broadcasting service offered via existing GSM and UMTS cellular networks. Recently, evolved MBMS (E-MBMS) has been introduced in the LTE specification for broadcasting or multicasting TV, films, and other information such as overnight transmission of newspapers in a digital form. To facilitate MBMS in LTE systems, a multicast control channel (MCCH) is used for the transmission of MBMS control information in each MBMS Single Frequency Network (MBSFN) area, and a multicast traffic channel (MTCH) is used for the transmission of user traffic to UEs receiving MBMS data packets. MBMS has the major benefit that the network infrastructure already exists for mobile network operators and that deployment can be cost effective compared with building a new network for the service. The broadcast capability enables to reach unlimited number of users with constant network load. The broadcast capability also enables the possibility to broadcast information simultaneously to many cellular subscribers, such as emergency alerts.

An important feature of a mobile wireless system such as LTE is the support for seamless mobility across eNBs and the entire network. Fast and seamless handover (HO) is particularly important for delay-sensitive services such as VoIP. Likewise, MBMS service continuity is also important for MBMS user experience. The mobility of a UE should affect MBMS service reception as less as possible. However, there is no network-assisted MBMS service continuity supported by the current LTE specification (e.g., in LTE Rel-9). Furthermore, with the addition of carrier aggregation (CA) in LTE-A systems, and with the possibility of network base stations (e.g., eNBs) covered by multiple MBSFN areas, it is foreseeable that an eNB can be associated with more than one MBSFN areas. Network-assisted solutions for MBMS service continuity are sought.

### SUMMARY

Network-assisted solutions are provided to maintain MBMS service continuity. In one novel aspect, a base station broadcasts MBMS service continuity (SC) indication to a plurality of user equipments (UEs) via a system information block (SIB). The MBMS SC indication comprises MBMS service area IDs (SAIs) supported by the current cell as well as neighbor frequencies.

If a UE is in RRC_IDLE state, then the UE makes cell reselection decision based on the MBMS SC indication to maintain MBMS service continuity.

If the UE is in RRC_CONNECTED state, then the UE reports MBMS reception status to the base station based on the MBMS SC indication via a dedicated RRC message. In one example, the MBMS reception status comprises carrier frequencies that support specific MBMS service the UE is interested in, as well as UE's preference of MBMS over unicast. As a result, the base station can makes certain decisions including handover for the UE to maintain MBMS service continuity.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a logical architecture of an LTE system supporting MBMS service in accordance with one novel aspect.

FIG. 2 is a simplified block diagram of a serving base station and a user equipment in accordance with one novel aspect.

FIG. 3A illustrates network-assisted MBMS service continuity in an MBMS service area in accordance with one novel aspect.

FIG. 3B illustrates a first example of an MBMS service continuity indication.

FIG. 3C illustrates a second example of an MBMS service continuity indication.

FIG. 4 illustrates a network-assisted solution for MBMS service continuity in an LTE system for RRC_IDEL mode in accordance with one novel aspect.

FIG. 5 illustrates a network-assisted solution for MBMS service continuity in an LTE system for RRC_CONNECTED mode in accordance with one novel aspect.

FIG. 6 is a flow chart of a method of MBMS service continuity from network perspective in accordance with one novel aspect.

FIG. 7 is a flow chart of a method of MBMS service continuity from user equipment perspective in accordance with one novel aspect.

### DETAILED DESCRIPTION

Reference will now be made in detail to some embodiments of the invention, examples of which are illustrated in the accompanying drawings.

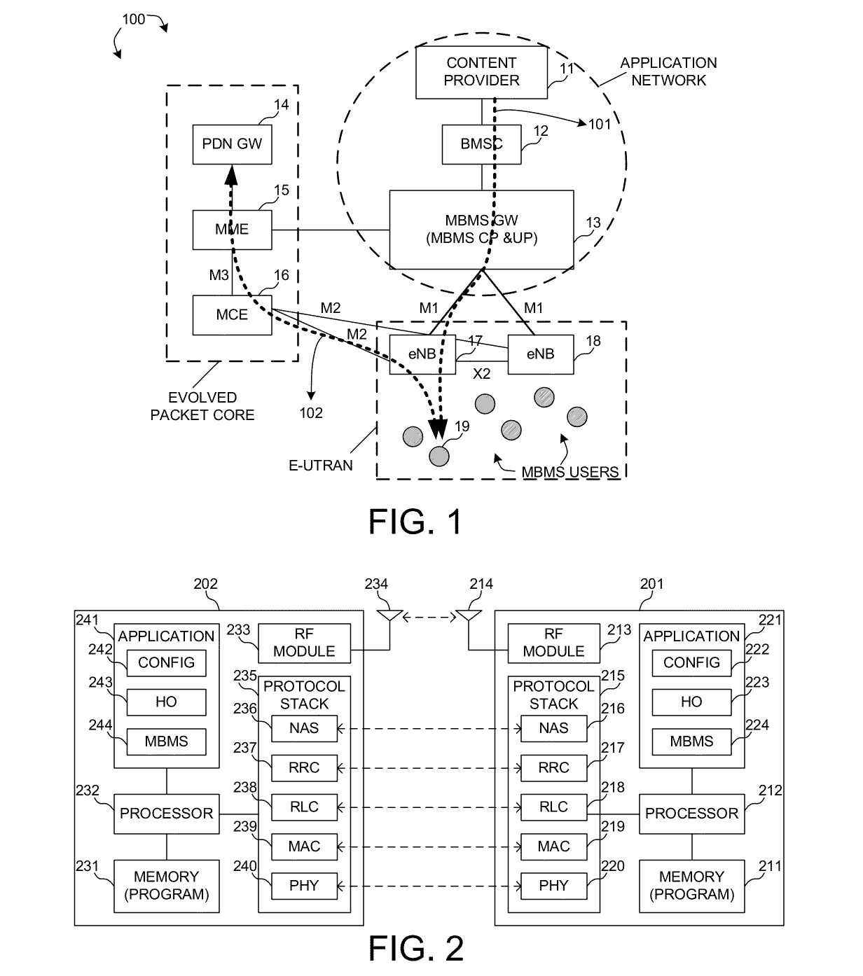

FIG. 1 illustrates a logical architecture of an Long-Term Evolution (LTE) system 100 supporting Evolved Multimedia Broadcast and Multicast Service (E-MBMS) service in accordance with one novel aspect. LTE system 100 comprises a content provider 11, a Broadcast Multicast Service Center (BMSC) 12, an MBMS gateway (MBMS-GW) 13 for MBMS CP&UP, a packet data network gateway (PDN-GW) 14, a mobility management entity (MME) 15, a multi-cell/multicast coordination entity (MCE) 16, two evolved Node-Bs eNB 17 and eNB 18, and a plurality of MBMS users (e.g., user equipment UE 19).

When UE 19 subscribes to a specific MBMS service, MBMS data packets are transmitted from content provider 11, through BMSC 12, through MBMS GW 13, through eNB 17, and then to UE 19 (e.g., depicted by a dotted line 101). On the other hand, MBMS control information is communicated between PDN-GW 14 and UE 19 via MME 15, MCE 16 and eNB 17 (e.g., depicted by a dotted line 102). As illustrated in FIG. 1, eNB 17 and eNB 18 are connected to MBMS GW 13 via a pure user plane interface M1. MBMS GW 13 is a logical entity whose main function is broadcasting MBMS packets with SYNC protocol to each eNB transmitting a corresponding MBMS service.

In addition to the M1 interface, two control plane interfaces M2 and M3 are defined in LTE system 100. The application part on the M2 interface conveys radio configuration information between the eNBs and MCE 16, and the application part on the M3 interface performs MBMS session control signaling on MBMS bearer level between MCE 16 and MME 15. MCE 16 is a logical entity, which can also be part of another network element such as inside an eNB. MCE 16 performs functions such as the allocation of the radio resources used by all the eNBs in an MBMS Single Frequency Network (MBSFN) area as well as determining the radio configuration including the modulation and coding scheme (MCS).

In accordance with one novel aspect, network-assisted solutions are provided to maintain MBMS service continuity (SC). From the network perspective, eNB indication of SC support (e.g., MBMS service area ID (SAI)) is broadcasted through a new dedicated system information block (SIB). The existence of the new SIB provides indication to the UE whether the serving cell supports MBMS SC. From the MBMS user perspective, UE MBMS reception or interest status is sent to eNB according to the content of the new SIB. The UE indicates its preference between unicast and MBMS, as well as reports its MBMS reception or interest within its capabilities.

FIG. 2 is a simplified block diagram of a user equipment UE 201 and a serving base station eNB 202 in accordance with one novel aspect. UE 201 comprises memory 211, a processor 212, a radio frequency (RF) module 213 coupled to antenna 214, a protocol stack module 215 supporting various protocol layers including NAS 216, RRC 217, RLC 218, MAC 219 and PHY 220, and an application module 221 including a configuration module 222, a handover (HO) module 223, and an MBMS control module 224. Similarly, Base station eNB 202 comprises memory 231, a processor 232, a radio frequency (RF) module 233 coupled to antenna 234, a protocol stack module 235 supporting various protocol layers including NAS 236, RRC 237, RLC 238, MAC 239 and PHY 240, and an application module 241 including a configuration module 242, a handover (HO) module 243, and an MBMS control module 244.

The various modules are function modules and may be implemented by software, firmware, hardware, or any combination thereof. The function modules, when executed by processors 212 and 232, interwork with each other to allow UE 201 to receive MBMS service and to maintain service continuity after handover or cell reselection under network assistance provided by eNB 202. For example, configuration module 222 receives MSMS related information from eNB 202, HO module 223 performs handover or cell reselection procedure, and MBMS control module 224 reports MBMS reception/interest status to eNB 202 to facilitate the support for MBMS service continuity with less MBMS service interruption. In another example, protocol stack modules RRC 217 and RRC 237 process RRC layer messages such that UE MBMS reception or interest status is reported from UE 201 to eNB 202 via RRC signaling.

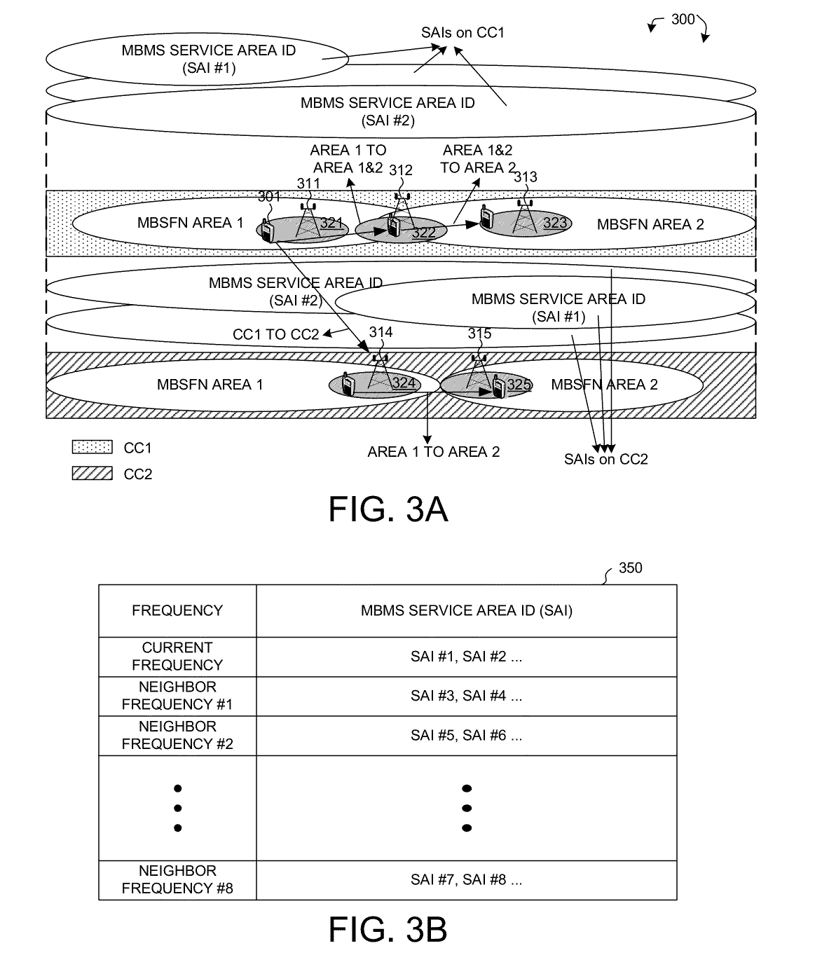

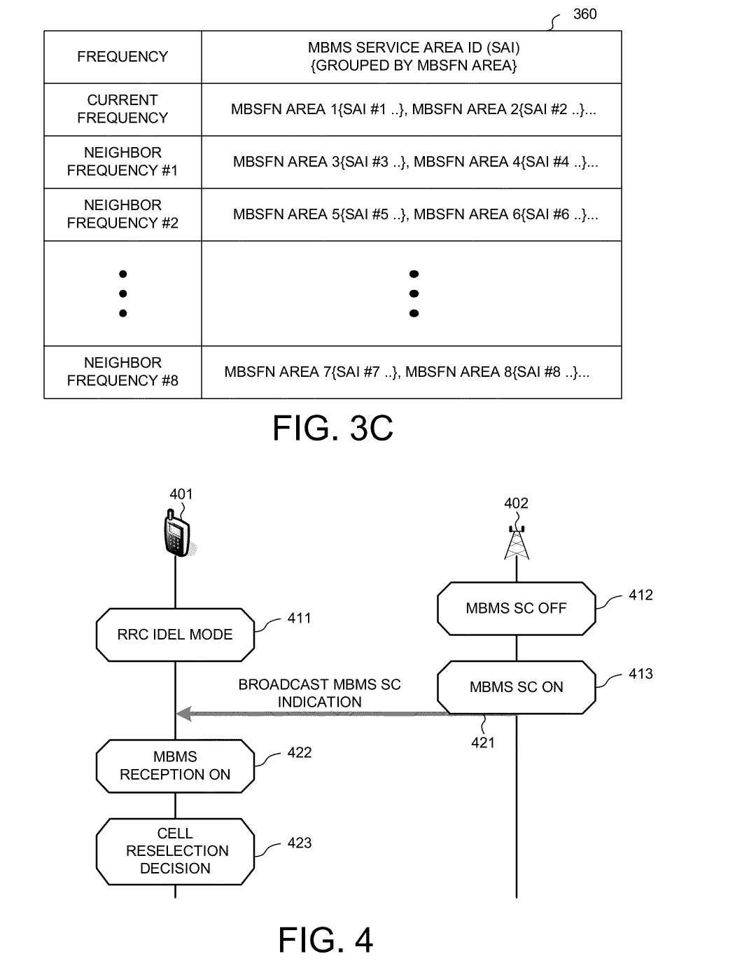

FIG. 3A illustrates network-assisted MBMS service continuity in MBMS service (or synchronization) areas 300 in accordance with one novel aspect. MBMS service areas 300 cover multiple MBSFN areas (e.g., MBSFN areas 1-2 for component carrier CC1 and CC2). An MBSFN area comprises a group of cells within an MBNFS service area of a network that are co-ordinate to achieve MBSFN transmission. An MBSFN service area is defined as an area of network in which all eNBs can be synchronized to perform MBSFN transmission. MBMS service areas are capable of supporting one or more MBSFN areas. On a given frequency layer (e.g., one CC), an eNB can only belong to one MBMS service area. Under the MBMS service area, a cell can belong to one or more MBSFN areas and support MBMS service for all the belonging MBSFN areas.

In the example of FIG. 3A, eNB 311 belongs to MBSFN area 1 and serves cell 321 for MBMS service over CC1, eNB 312 belongs to both MBSFN area 1 and area 2 and serves cell 322 for MBMS service over CC1, eNB 313 belongs to MBSFN area 2 and serves cell 323 for MBMS service over CC1, eNB 314 belongs to MBSFN area 1 and serves cell 324 for MBMS service over CC2, and eNB 315 belongs to MBSFN area 2 and serves cell 325 for MBMS service over CC2. UE 301 initially subscribes to a specific MBMS service in cell 321 served by eNB 311, and later moves around to different cells served by different eNBs. In one example, UE 301 first receives subscribed MBMS service in MBSFN area 1 in cell 321 over CC1, then moves to MBSFN area 1&2 in cell 322 over CC1, and then moves to MBSFN area 2 in cell 323 over CC1. In another example, UE 21 first receives MBMS service in MBSFN area 1 in cell 321 over CC1, then moves to MBSFN area 1 in cell 324 over CC2, and then moves to MBSFN area 2 in cell 325 over CC2.

When UE 301 moves from cell to cell, UE 301 will either perform handover or cell reselection. In LTE systems, two radio resource control (RRC) states namely RRC_IDLE and RRC_CONNECTED are defined. A UE moves from RRC_IDLE state to RRC_CONNECTED state when an RRC connection is successfully established. A UE can move back from RRC_CONNECTED state to RRC_IDLE state by releasing the RRC connection. In the RRC_IDLE state, UE can receive broadcast/multicast data, monitors a paging channel to detect incoming calls, performs neighbor cell measurements and cell selection/reselection, and acquires system information. Mobility is controlled by the UE in the RRC_IDLE state. In the RRC_CONNECTED state, the transfer of unicast data to/from UE, and the transfer of broadcast/multicast data to UE can take place. The UE monitors control channels associated with the shared data channel to determine scheduled data, provides channel quality feedback information, performs neighbor cell measurements and measurement reporting, and acquires system information. Unlike the RRC_IDLE state, mobility and handovers in the RRC_CONNECTED state are network-controlled and assisted by the UE.

In one novel aspect, eNB broadcasts MBMS service continuity (SC) indication to UEs via a new SIB. The MBMS SC indication contains MBMS service area ID (SAI) supported by the current cell and neighbor frequencies. When UE 301 is in RCC_IDLE state, UE 301 can make cell reselection decision based on the received MBMS SC indication to maintain service continuity. On the other hand, when UE 301 is in RCC_CONNECTED state, UE 301 reports its MBMS reception status to its serving eNB based on the received MBMS SC indication via dedicated RRC signaling. The MBMS reception status contains information on UE's interest for specific MBMS service and UE's preference of MBMS service over unicast service. Note that in this invention, there is no difference between UE reception status and interest status. When a UE indicates it is interested in a plurality of services, it means it can receive said services at the same time (e.g., within its capability). From eNB point of view, from the UE reception status report and the UE carrier aggregation (CA) capability, eNB can clearly know the remaining capability of the UE (e.g. idle receiver chain). As a result, follow-up carrier aggregation operation will not cause unintended MBMS reception interruption. When handover is considered necessary, the serving eNB will make handover decisions—additionally taking MBMS information of neighbor cells and UE's MBMS reception status into consideration—such that MBMS service continuity can be maintained with less interruption.

Note that the MBMS information of neighbor cells is different from the MBMS SC indication. In this invention, MBMS information consists of MBSFN subframe configuration in System Information Block 2 (SIB2), MBMS Area ID and MCCH configuration in System Information Block 13 (SIB13), PMCH configuration and service list in MCCH (RRC message). In addition, a new System Information Block is used to carry MBMS service are ID (SAI) for current cell and neighboring frequencies, which is also considered as part of MBMS information. The existence of this new System Information Block implicitly indicated whether the current cell supports MBMS SC, and the new SIB content is thus referred to as MBMS SC indication. While the MBMS information is used for many MBMS related functionalities, the MBMS SC indication is mainly used for the support of MBMS service continuity. In one example, the MBMS SC indication contains a maximum number of 64 MBMS SAIs for the current cell, a maximum of 64 MBMS SAIs per neighbor frequency, and a maximum of eight neighbor frequencies.

FIG. 3B illustrates a first example of MBMS SC information in table 350. In the example of FIG. 3B, the MBMS SC indication contains one serving cell entry for current frequency and eight neighbor frequencies. Each carrier frequency is associated with a list of up to 64 MBMS service area IDs (SAIs). Alternatively, each carrier frequency is associated with a list of MBMS service IDs. For example, an MBMS service IDs may be represented by a Temporary MBMS Group Identity (TMGI).

FIG. 3C illustrates a second example of MBMS SC information in table 360. In the example of FIG. 3C, the MBMS SC indication contains one serving cell entry for current frequency and eight neighbor frequencies. Each carrier frequency is associated with a list of up to 64 MBMS service area IDs (SAIs). Since providing MBSFN area ID can save UE power on monitoring/reading MCCH, the SAI of each frequency is grouped by MBSFN area ID.

FIG. 4 illustrates a network-assisted solution for MBMS service continuity in an LTE system 400 for RCC_IDLE mode in accordance with one novel aspect. LTE system 400 comprises a user equipment UE 401 and a base station eNB 402. UE 401 has not established any RRC connection with eNB 402 and stays in RRC_IDLE state (step 411). UE 401 is not receiving or interested in receiving any MBMS service. At the network side, eNB 402 initially does not support the feature of MBMS service continuity, e.g., MBMS SC is OFF (step 412). Later, eNB 402 starts to support the feature of MBMS service continuity and MBMS SC is ON (step 413). Once eNB 402 turns on the feature of MBMS SC, eNB 402 starts to broadcast MBMS SC indication to UEs including UE 401 via a new SIB (step 421). The MBMS SC indication contains MBMS service area IDs (SAIs) supported by the current cell (e.g., the serving carrier frequency), as well as SAIs supported by each neighbor frequency. To have a specific UE behavior, the cell reselection (step 423) shall consider MBMS information only when the UE is interested in receiving MBMS service. The UE not only considers signal strength, but also considers MBMS information to do reselection such that the UE can continue its MBMS service after cell reselection. On the other hand, when the UE is no longer interested in receiving any MBMS service, the cell reselection decision (step 423) shall no longer consider any MBMS information.

Typically, the existence of the new SIB indicates the support of MBMS SC. In one embodiment, a binary indication of whether MBMS SC is supported can be broadcasted. In another embodiment, what kind of MBMS SC is supported can be broadcasted. For example, intra-MBSFN area, inter-MBSFN area, intra-frequency, or inter-frequency service continuity is reported. Later on, UE 401 starts to receive a specific MBMS service supported by the current cell (step 422). When UE 401 changes location, it makes cell reselection decision to maintain MBMS service continuity (step 423). Because UE 401 knows MBMS service supported by each cell from the broadcasted MBMS SC indication, UE 401 is able to make proper cell reselection decision such that the interested MBMS service can be continued after cell reselection.

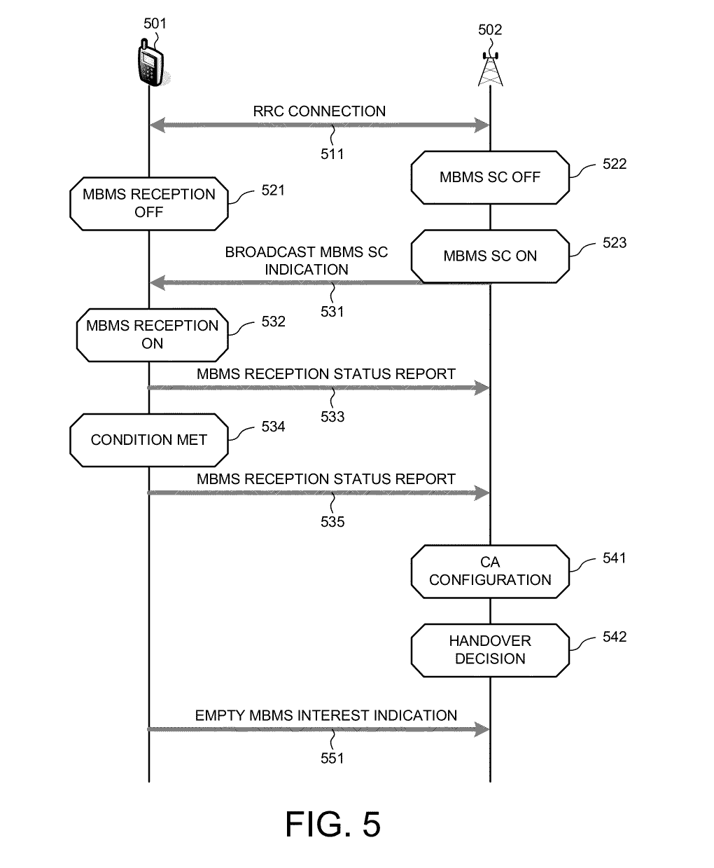

FIG. 5 illustrates a network-assisted solution for MBMS service continuity in an LTE system 500 for RRC_CONNECTED mode in accordance with one novel aspect. LTE system 500 comprises a user equipment UE 501 and a serving base station eNB 502. UE 501 establishes an RRC connection with its serving eNB 502 and is in RRC_CONNECTED state (step 511). Initially, UE 501 is not receiving or interested in receiving any MBMS service (step 521). At the network side, eNB 502 initially does not support the feature of MBMS service continuity, e.g., MBMS SC is OFF (step 522). Later, eNB 502 starts to support the feature of MBMS service continuity and MBMS SC is ON (step 523). Once eNB 502 turns on the feature of MBMS SC, eNB 502 starts to broadcast MBMS SC indication to UEs including UE 501 via a new SIB (step 531). The MBMS SC indication contains MBMS service area IDs (SAIs) supported by the current cell (e.g., the serving carrier frequency), as well as SAIs supported by each neighbor frequency.

Later on, UE 501 starts to receive a specific MBMS service supported by the current cell (step 532). In accordance with one novel aspect, if UE 501 starts to receive or is interested in receiving MBMS service, and eNB has indicated MBMS SC support, then UE 501 initiates MBMS report procedure. During the MBMS report procedure, UE reports its MBMS reception status according to the received MBMS SC indication to its serving eNB. In one embodiment, UE 501 reports its MBMS reception status through a dedicated RRC message (e.g., MBMSInterestIndication) (step 533). The UE MBMS reception status indicates that the UE is receiving or interested in certain MBMS service, as well as UE's preference of MBMS service over unicast service. In one example, UE 501 is interested in receiving a specific MBMS service that is supported by a certain carrier frequency, and UE 501 reports that carrier frequency in the MBMS reception status. In another example, UE 501 using one bit in the MBMS reception status to indicate whether MBMS service continuity is preferred over unicast service.

The reported MBMS reception status is within both the network and the UE capability. From the network side, the reported carrier frequency must be listed in the MBMS SC indication broadcasted via the new SIB. From the UE side, UE reports the MBMS service it can indeed receive within its UE capability. For example, if UE 501 has two radio frequency modules, then UE 501 reports no more than two carrier frequencies for interested MBMS service.

When to report the MBMS reception status can be configured by the network. For example, the MBMS reception status is reported via event trigger (e.g., A1-A6, B1-B2), or periodically reported based on a periodic timer. UE may also autonomously report the MBMS reception status upon receiving the MBMS SC indication. In one embodiment, UE checks whether a condition is met for MBMS reception status reporting (step 534). If the condition is satisfied, then UE 501 reports MBMS reception status to eNB 502 again (step 535). The condition may include UE changes its MBMS interest or its MBMS preference over unicast. The condition may also be satisfied upon expiration of the periodic timer.

Upon receiving the MBMS reception status report from UE 501, eNB 502 can make certain decisions for UE 501. In one embodiment, eNB 502 determines carrier aggregation configuration for UE 501 based on UE traffic and additionally the MBMS reception status report (step 541). For example, if UE 501 is using one CC for unicast and another CC for MBMS, and UE 501 has indicated that MBMS service is preferred over unicast service, then eNB 502 will not configure CA for UE 501 if MBMS service will be interrupted. On the other hand, if UE 501 has indicated that MBMS is not preferred over unicast service, then eNB 502 will configure CA for UE 501. In another embodiment, eNB 502 makes handover decisions for UE 501 based on the MBMS reception status report and other MBMS information of neighbor cells (step 542). For example, eNB 502 determines a target cell from the neighbor cells. The target cell supports the same MBMS service as reported by UE 501 so that MBMS service continuity is maintained after handover.

In step 551, UE 501 stops the MBMS report procedure if it is no longer interested in MBMS service, or eNB 502 does not support SC anymore. For example, UE 501 sends an empty MBMSInterestIndication to indicate that UE 501 is no longer interested in receiving any MBMS service, and stops MBMS report procedure.

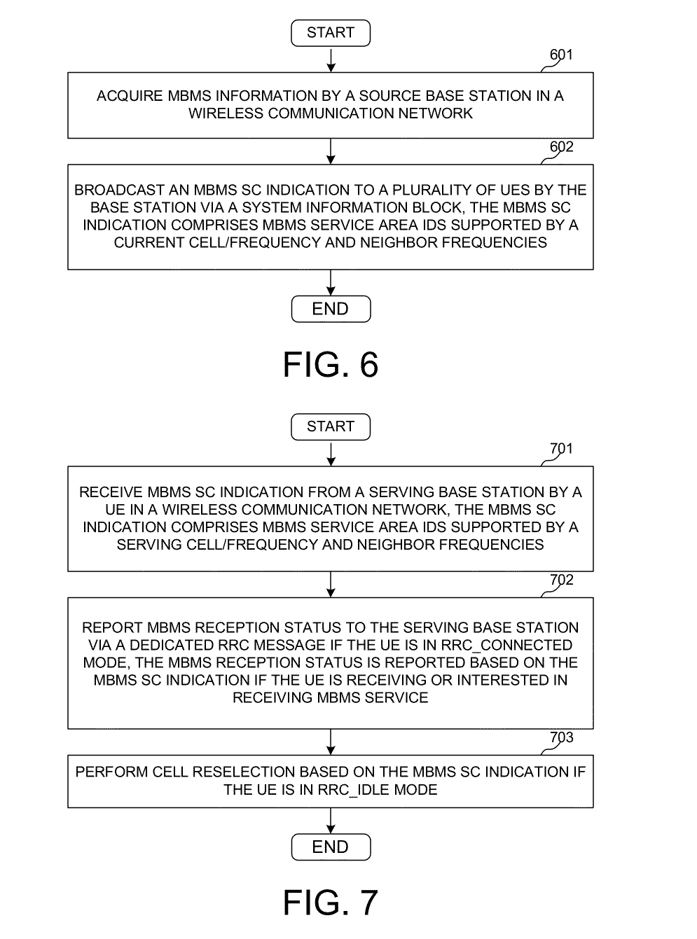

FIG. 6 is a flow chart of a method of MBMS service continuity from network perspective in accordance with one novel aspect. In step 601, a base station acquires MBMS information of neighbor frequencies in a wireless communication network. In one example, the base station acquires the MBMS information via network entities such as an Operation, Administration, and Maintenance (OAM) server. In step 602, the base station broadcasts an MBMS service continuity (SC) indication to a plurality of UEs via a System Information Block (SIB). The MBMS SC indication comprises MBMS service area IDs (SAIs) supported by the current cell as well as neighbor frequencies.

FIG. 7 is a flow chart of a method of MBMS service continuity from user equipment perspective in accordance with one novel aspect. In step 701, a user equipment (UE) receives MBMS service continuity (SC) indication broadcasted by a base station. The MBMS SC indication comprises MBMS service area IDs (SAIs) supported by the current cell as well as neighbor frequencies. In step 702, if the UE is in RRC_CONNECTED state, then the UE reports MBMS reception status to the base station via a dedicated RRC message. The MBMS reception status is reported based on the received MBMS SC indication only if the UE is receiving or is interested in receiving MBMS service. In one example, the MBMS reception status comprises carrier frequencies that support specific MBMS service the UE is interested in, as well as UE's preference of MBMS over unicast. Based on the reported MBMS reception status, the base station can make proper decisions such as carrier aggregation (CA) and handover (HO) to meet UE's expectation such including MBMS service continuity. In step 703, if the UE is in RRC_IDLE state, then the UE performs cell reselection based on the MBMS SC indication to maintain MBMS service continuity.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
acquiring multimedia broadcast multicast service (MBMS) information by a base station in a wireless communication network; and
broadcasting an MBMS service continuity (SC) indication to a plurality of user equipments (UEs) by the base station via a system information block (SIB), wherein the MBMS SC indication comprises MBMS service area IDs (SAIs) supported by a current cell/frequency and neighbor frequencies.

2. The method of claim 1, wherein the MBMS information comprises at least one of an MBMS single frequency network (MBSFN) subframe configuration and an MBSFN area ID supported by each neighbor cell.

3. The method of claim 1, wherein each neighbor frequency is associated with a list of MBMS service IDs supported by a corresponding cell.

4. The method of claim 1, further comprising:
receiving MBMS reception status information from a UE in response to the MBMS service continuity indication.

5. The method of claim 4, wherein the MBMS reception status information comprises one or more carrier frequencies that the UE is receiving or interested in receiving MBMS, and a preference of MBMS over unicast of the UE.

6. The method of claim 4, further comprising:
determining carrier aggregation configuration for the UE based on the MBMS information and the MBMS reception status information.

7. The method of claim 4, further comprising:
determining a target cell from the neighbor cells for the UE based on the MBMS information and the MBMS reception status information.

8. A method comprising:
receiving multimedia broadcast multicast service (MBMS) service continuity (SC) indication from a serving base station by a user equipment (UE) in a wireless communication network, wherein the MBMS SC indication comprises MBMS service area IDs (SAIs) of a serving cell/frequency and neighbor frequencies;
reporting MBMS reception status to the serving base station via a dedicated radio resource control (RRC) message if the UE is in RRC_CONNECTED mode, wherein the UE reports the MBMS reception status based on the MBMS SC indication if the UE is receiving MBMS service or is interested in receiving MBMS service; and
making cell reselection decision based on the MBMS SC indication if the UE is in RRC_IDLE mode.

9. The method of claim 8, further comprising:
updating MBMS reception status to the serving base station if a condition is satisfied, wherein the condition comprises MBMS reception or interest change, MBMS over unicast preference change, and MBMS timer expiration.

10. The method of claim 8, wherein the UE sends an empty MBMS reception status to the serving base station if the UE is no longer receiving or interested in receiving MBMS service.

11. The method of claim 8, wherein the MBMS reception status contains one bit that indicates whether the UE prefers MBMS service or unicast service.

12. The method of claim 8, wherein the MBMS reception status contains one or more carrier frequencies associated with specific MBMS service that the UE is interested based on the MBMS SC indication.

13. The method of claim 12, wherein all the reported carrier frequencies are listed in the broadcasted MBMS SC indication.

14. The method of claim 12, wherein the UE is capable of receiving the specific MBMS service over all the reported carrier frequencies.

15. A user equipment (UE), comprising:
a radio frequency module that receives multimedia broadcast multicast service (MBMS) service continuity (SC) indication from a serving base station in a wireless communication network, wherein the MBMS SC indication comprises MBMS service area IDs (SAIs) of a serving cell/frequency and neighbor frequencies;
an MBMS control module that reports MBMS reception status to the serving base station via a dedicated radio resource control (RRC) message if the UE is in RRC_CONNECTED mode, wherein the UE reports the MBMS reception status based on the MBMS SC indication if the UE is receiving MBMS service or is interested in receiving MBMS service; and
a handover module that makes cell reselection decision based on the MBMS SC indication if the UE is in RRC_IDLE mode.

16. The UE of claim 15, wherein the UE reports updated MBMS reception status to the serving base station if a condition is satisfied, wherein the condition comprises MBMS reception or interest change, MBMS over unicast preference change, and MBMS timer expiration.

17. The UE of claim 15, wherein the UE sends an empty MBMS reception status to the serving base station if the UE is no longer receiving or interested in receiving MBMS service.

18. The UE of claim 15, wherein the MBMS reception status contains one bit that indicates whether the UE prefers MBMS service or unicast service.

19. The UE of claim 15, wherein the MBMS reception status contains one or more carrier frequencies associated with specific MBMS service that the UE is interested based on the MBMS SC indication.

20. The UE of claim 19, wherein all the reported carrier frequencies are listed in the broadcasted MBMS SC indication.

21. The UE of claim 19, wherein the UE is capable of receiving the specific MBMS service over all the reported carrier frequencies.
